(19) United States
(12) Patent Application Publication
(10) Pub. No.: US 2014/0191966 A1
(43) Pub. Date: Jul. 10, 2014

(54) INTERACTIVE IMAGE SYSTEM AND OPERATING APPARATUS THEREOF

(71) Applicant: PixArt Imaging Inc., Hsinchu City (TW)

(72) Inventors: CHIA-CHEUN LIANG, Hsinchu City (TW); WEN-YU YANG, Hsinchu City (TW); CHIH-YEN WU, Hsinchu City (TW)

(73) Assignee: PixArt Imaging Inc., Hsinchu City (TW)

(21) Appl. No.: 13/965,172

(22) Filed: Aug. 12, 2013

(30) Foreign Application Priority Data
Jan. 8, 2013 (TW) 102100581

(51) Int. Cl. G06F 3/03

(52) U.S. Cl. CPC G06F 3/0308
USPC 345/158

(57) ABSTRACT

An operating apparatus adapted to manipulate an operating interface of a display device and having a switchable operation mode is provided. The display device is adapted to provide a first optical signal. The operating apparatus includes a processing module, a light-emitting element, a light sensing element and a switching module. The light-emitting element, the light sensing element and the switching module are electrically connected to the processing module. The switching module is adapted to switch the switchable operation mode to a first mode or a second mode. When the switchable operation mode is switched to the first mode, the light sensing element receives the first optical signal. When the switchable operation mode is switched to the second mode, the light-emitting element provides a second optical signal and the light sensing element receives the second optical signal. An interactive image system having the operating apparatus is also provided.

### FIELD OF THE INVENTION

The present invention relates to an interactive image system and an operating apparatus thereof, and more particularly to an operating apparatus having a switchable operation mode and an interactive image system having the operating apparatus.

### BACKGROUND OF THE INVENTION

In recent years, interactive image systems are rapidly developed. The interactive image systems are broadly used in various fields such as advertisement, art, education, entertainment, engineering and medicine etc., and have kept intimate relations with ordinary life. Common interactive image system includes a display device and a controller. A user could move the controller to generate control signals and further control movement of a cursor of a controlling interface displayed on the display device so as to manipulate a selection or a function of the controlling interface.

The controller of a conventional interactive image system may be a direct-pointing remote controller. The direct-pointing remote controller usually includes a sensing module for receiving an optical signal emitted by a signal emitting element of the display device. Due to movement of the direct-pointing remote controller, the position where a sensing surface of the sensing module receives the optical signal is changed, such that movement information (including movement direction and movement distance) of the direct-pointing remote controller could be calculated. The direct-pointing remote controller could transmit the movement information to the display device so that the display device could move the cursor of the controlling interface according to the movement information. However, when the direct-pointing remote controller is actually used, the cursor could not be accurately controlled, which limits the usage of the direct-pointing remote controller.

### SUMMARY OF THE INVENTION

The present invention provides an operating apparatus having a switchable operation mode to accurately control movement of a cursor.

The present invention also provides an interactive image system, which includes an operating apparatus having a switchable operation mode to accurately control movement of a cursor.

An embodiment of the present invention provides an operating apparatus which is adapted to manipulate an operating interface displayed by a display device and has a switchable operation mode. The display device is adapted to provide a first optical signal. The operating apparatus includes a processing module, a light-emitting element, a light sensing element and a switching module. The light-emitting element, the light sensing element and the switching module are electrically connected to the processing module. The switching module is adapted to switch the switchable operation mode to a first mode or a second mode. When the switchable operation mode is switched to the first mode, the light sensing element receives the first optical signal. When the switchable operation mode is switched to the second mode, the light-emitting element provides a second optical signal and the switching module enables the light sensing element to receive the second optical signal.

An embodiment of the present invention further provides an interactive image system which includes a display device and the abovementioned operating apparatus. The display device is adapted to display an operating interface, while the operating apparatus is adapted to control the operating interface.

In summary, in the operating apparatus and the interactive image system of the present invention, the switching module is capable of switching the operation mode of the operating apparatus to the first mode or the second mode. When the operation mode is switched to the first mode, the operating apparatus could be used as a direct-pointing operating apparatus, and when the operation mode is switched to the second mode, the operating apparatus could be used as an optical mouse. Therefore, the operating apparatus of the present invention could be accurately controlled.

### BRIEF DESCRIPTION OF THE DRAWINGS

The present invention will become more readily apparent to those ordinarily skilled in the art after reviewing the following detailed description and accompanying drawings, in which:

FIG. 1 is a schematic, three-dimensional view of an interactive image system according to an embodiment of the present invention.

FIG. 2A is a schematic view showing an operating apparatus which is switched to a first mode according to a first embodiment of the present invention.

FIG. 2B is a schematic view showing the operating apparatus which is switched to a second mode according to the first embodiment of the present invention.

FIG. 3A is a schematic view showing an operating apparatus which is switched to a first mode according to a second embodiment of the present invention.

FIG. 3B is a schematic view showing the operating apparatus which is switched to a second mode according to the second embodiment of the present invention.

FIG. 4A is a schematic view showing an operating apparatus which is switched to a first mode according to a third embodiment of the present invention.

FIG. 4B is a schematic view showing the operating apparatus which is switched to a second mode according to the third embodiment of the present invention.

FIG. 5A is a schematic view showing an operating apparatus which is switched to a first mode according to a fourth embodiment of the present invention.

FIG. 5B is a schematic view showing the operating apparatus which is switched to a second mode according to the fourth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

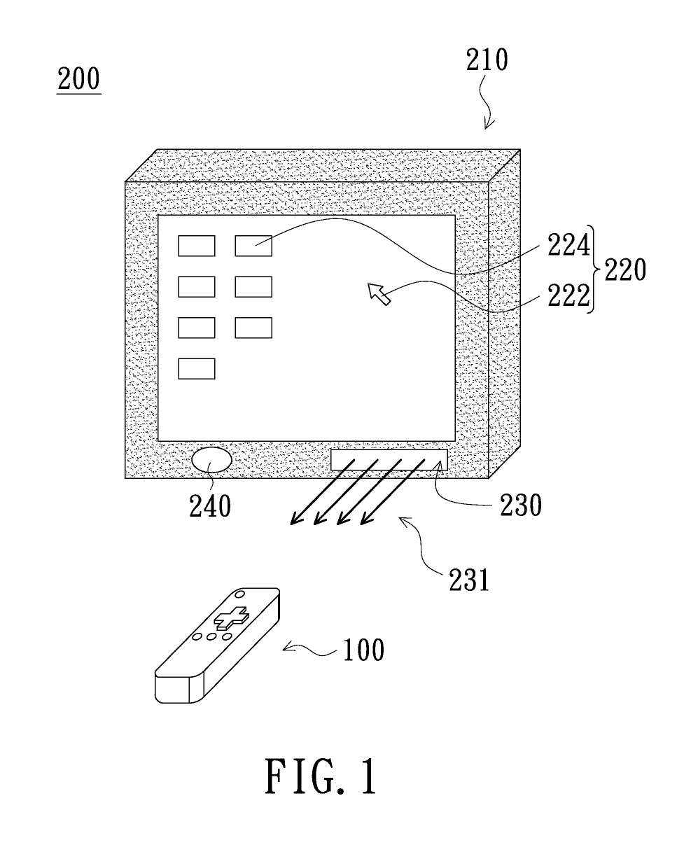

FIG. 1 shows a schematic, three-dimensional view of an interactive image system according to an embodiment of the present invention. Referring to FIG. 1, the interactive image system 200 includes a display device 210 and an operating apparatus 100. The operating apparatus 100 is adapted to manipulate an operating interface 220 displayed by the display device 210. The operating interface 220 includes, for example, but is not limited to, a cursor 222 and a plurality of icons 224. The operating apparatus 100 is capable of controlling the cursor 222 to move to one of the icons 224, and select the icon 224 to execute the function corresponding to the icon 224.

More specifically, the display device 210 includes a signal emitting element 230 and a signal receiving element 240. The signal emitting element 230 is adapted to emit a first optical signal 231 functioned as a locating signal, while the signal receiving element 240 is adapted to receive a signal emitted by the operating apparatus 100.

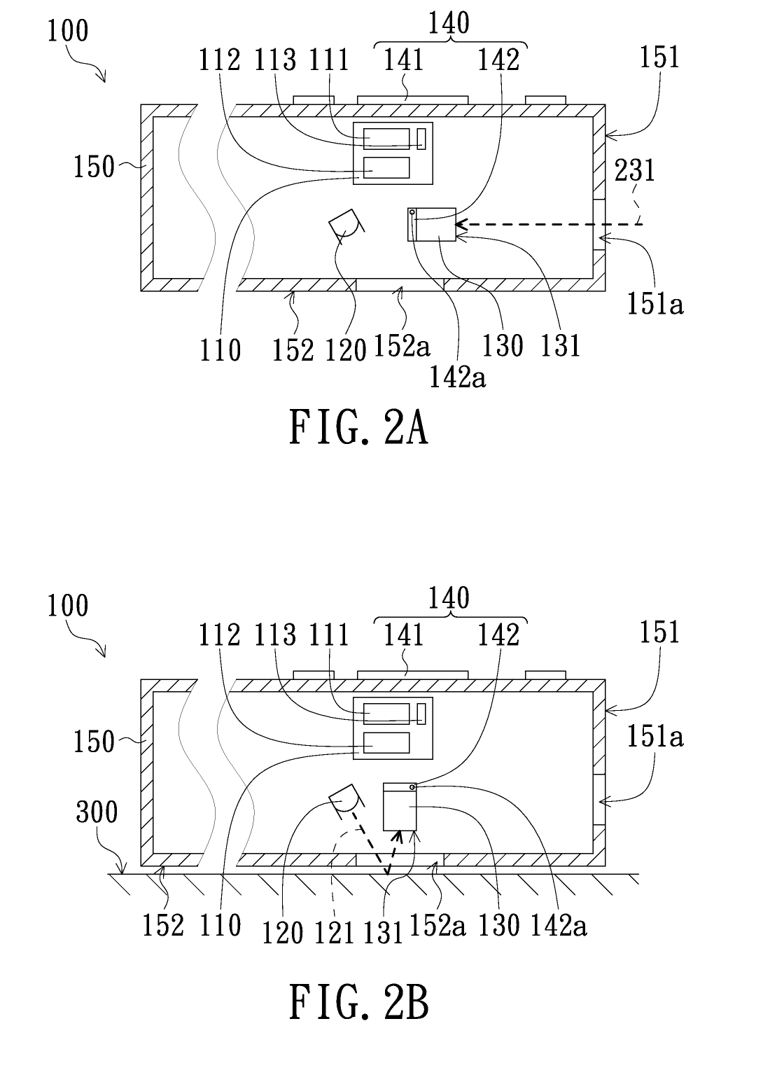

Referring to FIG. 2A, the operating apparatus 100 has a switchable operation mode, and includes a processing module 110, a light-emitting element 120, a light sensing element 130 and a switching module 140. The light-emitting element 120, the light sensing element 130 and the switching module 140 are electrically connected to the processing module 110. The connection manners of how the light-emitting element 120, the light sensing element 130 and the switching module 140 are electrically connected to the processing module 110 are not limited, and the connection manners are not shown in the drawings.

The light-emitting element 120 is adapted to provide a second optical signal 121. The light-emitting element 120 may be, but not limited to, a light emitting diode or a laser diode. The light sensing element 130 may be, but not limited to, a CMOS (complementary metal oxide semiconductor) image sensing element, a CCD (charged coupled device), or etc. The light sensing element 130 is capable of sensing the first optical signal 231 and the second optical signal 121. The processing module 110 is adapted to processing the signals sensed by the light sensing element 130. The first optical signal 231 and the second optical signal 121 may be infrared rays, or rays of other wavelengths, but invisible wavelengths are preferred.

The operating apparatus 100 of the embodiment, for example, further includes a casing 150. The processing module 110, the light-emitting element 120, the light sensing element 130 and the switching module 140 are disposed in the casing 150. The casing 150 has a first wall 151 and a second wall 152 interconnected with the first wall 151. The second wall 152 may be a bottom wall of the casing 150, while the first wall 151 may be a sidewall of the casing 150. The first wall 151 defines a first opening 151a therein, and the second wall 152 defines a second opening 152a therein. The configuration of the casing 150 is not limited. The first opening 151a may be covered by a light-pervious protecting cover (not shown).

The switching module 140 is adapted to switch the switchable operation mode to a first mode or a second mode. The switching module 140 of the embodiment, for example, includes a rotatable element 142. The rotatable element 142 is electrically connected to the processing module 110. The light sensing element 130 is fixed to the rotatable element 142. The rotatable element 142, fox example, is capable of rotating around a pivot axis 142a, so that the light sensing element 130 could face different orientations when the switchable operation mode is switched to different operation modes. For example, when the switchable operation mode is switched to the first mode (shown in FIG. 2A), a light sensing surface 131 of the light sensing element 130 is driven by the rotatable element 142 to face the first opening 151a. When the switchable operation mode is switched to the second mode (shown in FIG. 2B), the light sensing surface 131 of the light sensing element 130 is driven by the rotatable element 142 to face the second opening 152a.

Referring to FIGS. 1 and 2A, when the operation mode is switched to the first mode, a user could hold the operating apparatus 100 and let the first wall 151 of the operating apparatus 100 face the display device 210, such that the light sensing element 130 is capable of receiving the first optical signal 231 emitted by the signal emitting element 230 and passed through the first opening 151a. If the user moves the operating apparatus 100, the position where the light sensing surface 131 of the light sensing element 130 receives the first optical signal 231 is changed. That is, the position of the first optical signal 231 in images captured by the light sensing element 130 is changed. Therefore, the processing module 110 could calculate a pointing coordinate or movement information (including movement direction and movement distance) of the operating apparatus 100 according to information sensed by the light sensing element 130. Accordingly, the movement of the cursor 222 of FIG. 1 could be controlled. In other words, when the switchable operation mode is switched to the first mode, the operating apparatus 100 could be used as a direct-pointing operating apparatus.

Referring to FIG. 2B, when the operation mode is switched to the second mode, the user could place the operating apparatus 100 on a working surface 300 and let the second wall 152 face the working surface 300, and the processing module 110 drives the light-emitting element 120 to emit the second optical signal 121. The second optical signal 121 passes through the second opening 152a and reaches the working surface 300. The second opening 152a may be divided into two parts, in which a first part is provided for the optical signal 121 passing through from the light-emitting element 120, and a second part is provided for the optical signal 121 passing through from the reflection by the working surface 300. The working surface 300 reflects the second optical signal 121 to the light sensing surface 131 of the light sensing element 130. If the user moves the operating apparatus 100, the position where the light sensing surface 131 of the light sensing element 130 receives the second optical signal 121 is changed, and the processing module 110 calculates the movement information (including movement direction and movement distance) of the operating apparatus 100 according to the information sensed by the light sensing element 130, accordingly, the movement of the cursor 222 of FIG. 1 could be controlled. That is, when the switchable operation mode is switched to the second mode, the operating apparatus 100 could be used as an optical mouse.

In the embodiment, the switching module 140 may further include a switch key 141. The switch key 141 is disposed at the casing 150 and electrically connected to the processing module 110, and the connecting manner between the switch key 141 and the processing module 110 is not shown. The user could switch the switchable operation mode to the first mode or the second mode through the switch key 141. However, the manner to switch the switchable operation mode is not limited to using the switch key 141. In another embodiment, the switchable operation mode may be automatically switched and therefore the switch key 141 could be omitted. For example, the processing module 110 controls the switching module 140 to switch the switchable operation mode according to the image signals sensed by the light sensing element 130. For example, when the operation mode is switched to the second mode, it indicates the operating apparatus 100 has left the working surface 300 if the light sensing element 130 could not receive an efficient image signal, wherein the efficient image signal may be a signal whose average brightness or greatest brightness is equal to or higher than a predetermined value. The operating apparatus 100 could be automatically switched to the first mode if the light sensing element 130 could not receive an efficient image signal. Moreover, when the switchable operation mode is switched to the first mode, if the light sensing element 130 could not receive an efficient image signal (e.g. the light sensing element 130 dose not sense the pattern of the first optical signal 231 appeared in the image sensed by the light sensing element 130), this indicates the operating apparatus 100 is not aligned with the display device 210, and therefore the operating apparatus 100 could be automatically switched to the second mode. In this embodiment, it is set that the light sensing element 130 could identify the pattern of the first optical signal 231 appeared in the image sensed by the light sensing element 130 only in the condition that a number of pixels composed the pattern of the first optical signal 231 or brightness of the pixels composed the pattern of the first optical signal 231 is greater than a corresponding threshold.

In order to improve stability of the interactive image system 200, the interactive image system 200 may be set that the first mode could be automatically switched to the second mode or the second mode could be automatically switched to the first mode in the condition that the efficient image signal could not be detected in several continuous images or in a predetermined period of time. Furthermore, if the efficient image signal is not detected for one or more cycles (each cycle means a time period from the first mode to the following second mode or from the second mode to the following first mode), the operating apparatus 100 could be switched to a sleep mode to reduce image sensing frequency of the light sensing element 130, or the operating apparatus 100 could be stopped for a while and then be re-enabled to sense image.

The processing module 110 of the embodiment may include a first processing unit 111. The first processing unit 111 is electrically connected to the light sensing element 130. When the switchable operation mode is switched to the first mode, the first processing unit 111 could calculate the pointing coordinate or the movement information of the operating apparatus 100 according to the information sensed by the light sensing element 130. The processing module 110 may further include a second processing unit 112. The second processing unit 112 is electrically connected to the light sensing element 130. When the switchable operation mode is switched to the second mode, the second processing unit 112 could calculate the movement information of the operating apparatus 100 with respect to the working surface 300 according to the information sensed by the light sensing element 130. In another embodiment, the first processing unit 111 and the second processing unit 112 may be integrated into one processing unit.

When the switchable operation mode is switched to the first mode, the first processing unit 111 could calculate the imaging position of the first optical signal 231 in the image sensed by the light sensing element 130. Furthermore, the first processing unit 111 could calculate the pointing coordinate of the operating apparatus 100 according to the imaging position of the first optical signal 231 or calculate the coordinate information of the operating apparatus 100 according to the change of the imaging position of the first optical signal 231 in different images sensed by the light sensing element 130. When the switchable operation mode is switched to the second mode, the second optical signal 121 reflected by the working surface 300 is sensed by the light sensing element 130, and the second processing unit 112 could calculate the movement information of the operating apparatus 100 with respect to the working surface 300 according to the change of characteristics of the images (such as the change of the distribution of bright and dark areas in the images) sensed by the light sensing element 130. When the switchable operation mode is switched to the first mode, the calculation may be processed according to the common positioning technique of direct-pointing apparatus, while when the switchable operation mode is switched to the second mode, the calculation may be processed according to the common positioning technique of the optical mouse.

In addition, the processing module 110 may further include a transmission element 113. The transmission element 113 may be a wireless transmission element, and the transmission element 113 is electrically connected to the first processing unit 111 and the second processing unit 112. The first processing unit 111 and the second processing unit 112 could covert the movement information of the operating apparatus 100 into a corresponding control signal. The transmission element 113 transmits the control signal to the signal receiving element 240 of the display device 210 shown in FIG. 1. The display device 210 is capable of moving the cursor 222 displayed on the operating interface 220 according to the control signal. In another embodiment, the transmission element 113 may be a wire transmission element, or a transmission element integrated by a wire transmission and a wireless transmission element.

In the embodiment, the operating apparatus 100 utilizes the switching module 140 to switch the switchable operation mode. Therefore, the operating apparatus 100 not only could be used as a direct-pointing apparatus, but also could be used as an optical mouse when accurate control is needed, thereby efficiently solving the problem that the conventional direct-pointing apparatus could not accurately control the cursor.

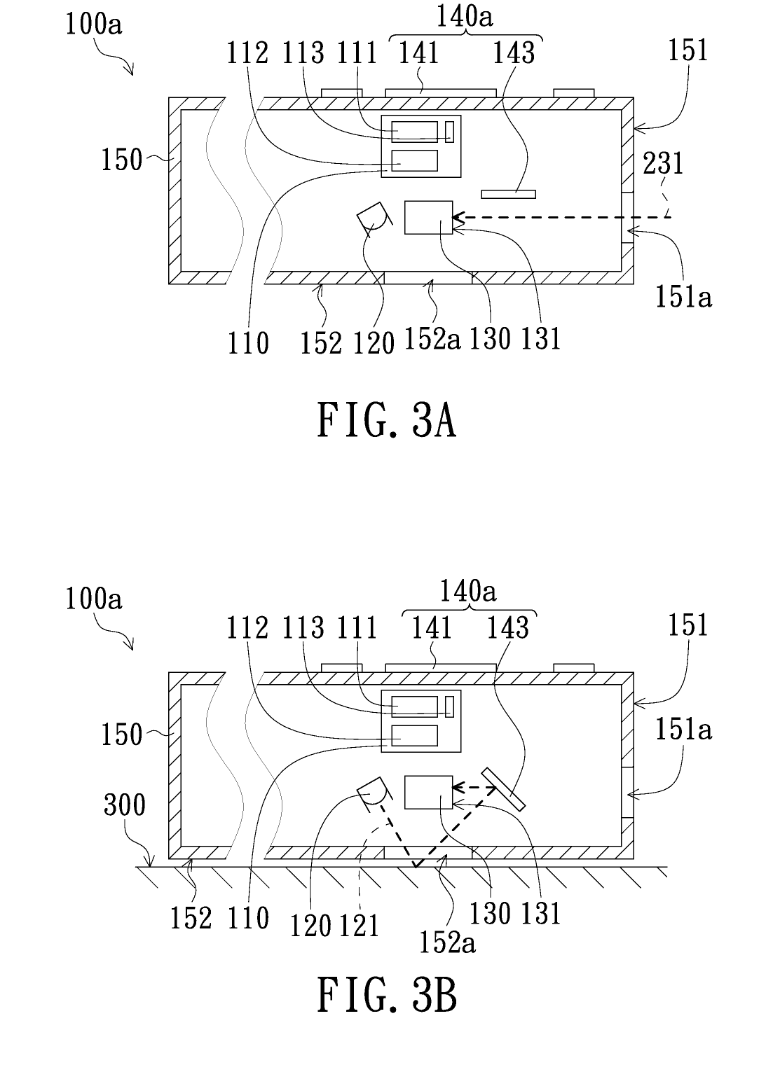

Referring to FIGS. 3A and 3B, the structure and advantages of the second embodiment of the operating apparatus 100a are similar to the first embodiment. The different between the first embodiment and the second embodiment is the switching module. More concretely, the switching module 140a of the operating apparatus 100a of the second embodiment utilizes a reflecting element 143 to replace the rotatable element 142 of the first embodiment. The reflecting element 143 is disposed between the light sensing element 130 and the first wall 151 of the casing 150, and the reflecting element 143 is electrically connected to the processing module 110. The reflecting element 143 may be, but not limited to, a reflective mirror. Moreover, the light sensing element 130 is arranged at a fixed position with the light sensing surface 131 facing the first opening 151a.

Referring to FIG. 3A, when the switchable operation mode is switched to the first mode, the processing module 110 drives the reflecting element 143 to move away from a position between the light sensing surface 131 and the first opening 151a, so that the first optical signal 231 entered into the casing 150 from the first opening 151a could be directly sensed by the light sensing surface 131 of the light sensing element 130.

Referring to FIG. 3B, when the switchable operation mode is switched to the second mode, the processing module 110 drives the reflecting element 143 to move to the position between the light sensing surface 131 and the first opening 151a, so that the second optical signal 121 reflected by the working surface 300 could be reflected to the light sensing surface 131 of the light sensing element 130 by the reflecting element 143, and thus the second optical signal 121 can be received by the light sensing surface 131.

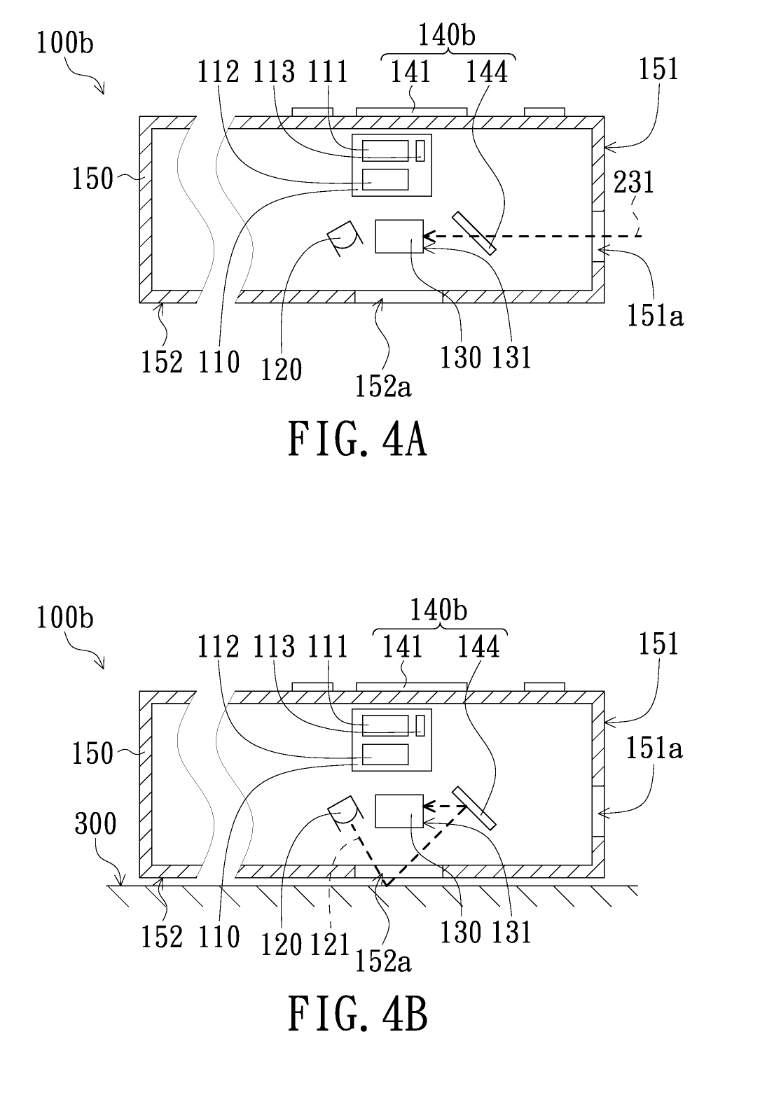

Referring to FIGS. 4A and 4B, the structure and advantages of the third embodiment of the operating apparatus 100b are similar to the first embodiment. The different between the first embodiment and the third embodiment is the switching module. More concretely, the switching module 140b of the operating apparatus 100b of the third embodiment utilizes an electronic polarization element 144 to replace the rotatable element 142 of the first embodiment. The electronic polarization element 144 is disposed between the light sensing element 130 and the first wall 151 of the casing 150, and the electronic polarization element 144 is electrically connected to the processing module 110. The light sensing element 130 is arranged at a fixed position with the light sensing surface 131 facing the first opening 151a. Moreover, both of the first optical signal 231 and the second optical signal 121 are polarized light.

Referring to FIG. 4A, when the switchable operation mode is switched to the first mode, the processing module 110 switches the electronic polarization element 144 to a first state. When the electronic polarization element 144 is switched to the first state, the electronic polarization element 144 allows the polarized light to pass through, so that the first optical signal 231 could pass through the electronic polarization element 144 and then be sensed by the light sensing surface 131 of the light sensing element 130.

Referring to FIG. 4B, when the switchable operation mode is switched to the second mode, the processing module 110 switches the electronic polarization element 144 to a second state. When the electronic polarization element 144 is switched to the second state, the electronic polarization element 144 reflects the polarized light, so that the second optical signal 121 reflected by the working surface 300 could be reflected to the light sensing surface 131 of the light sensing element 130 by the electronic polarization element 144, and thus the second optical signal 121 can be received by the light sensing surface 131.

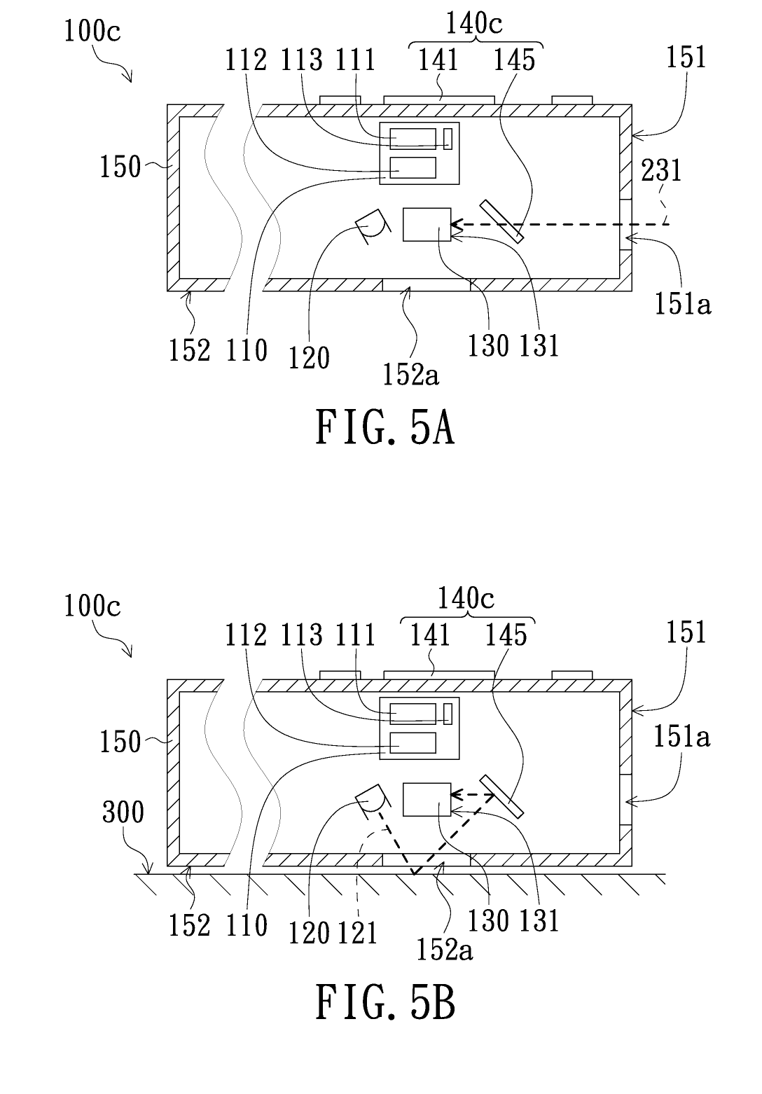

Referring to FIGS. 5A and 5B, the structure and advantages of the fourth embodiment of the operating apparatus 100c are similar to the third embodiment. The different between the third embodiment and the fourth embodiment is the switching module. More concretely, the switching module 140c of the operating apparatus 100c of the fourth embodiment utilizes an MEMS (Micro Electro Mechanical System) reflecting element 145 to replace the rotatable element 142 of the third embodiment. The MEMS reflecting element 145, for example, includes a base (not shown) and a plurality of micro reflectors (not shown) arranged on a supporting surface of the base in an array manner.

Referring to FIG. 5A, when the switchable operation mode is switched to the first mode, the processing module 110 switches the MEMS reflecting element 145 to a first state. When the MEMS reflecting element 145 is switched to the first state, the processing module 110 rotates each micro reflector to form an included angle between each micro reflector and the supporting surface of the base, and therefore, most area of the supporting surface are not covered by the micro reflectors, so that the first optical signal 231 could pass through the uncovered area of the MEMS reflecting element 145 and be received by the light sensing surface 131 of the light sensing element 130.

Referring to FIG. 5B, when the switchable operation mode is switched to the second mode, the processing module 110 switches the MEMS reflecting element 145 to a second state. When the MEMS reflecting element 145 is switched to the second state, the processing module 110 rotates the micro reflectors to parallel to the supporting surface of the base to make the whole area of the supporting surface be substantially covered by the micro reflectors, so that the second optical signal 121 reflected by the working surface 300 could be reflected to the light sensing surface 131 of the light sensing element 130 by the MEMS reflecting element 145, and thus the second optical signal 121 can be received by the light sensing surface 131.

In summary, the operating apparatus of the present invention could switch the switchable operation mode by the switching module, and therefore, the user could select the first mode or the second mode to operate the operating apparatus according to different environments or requirements. Accordingly, as compared to the conventional techniques, the user can select the operation mode to operate the operating apparatus according to different requirements so as to accurately control the operating interface.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operating apparatus adapted to manipulate an operating interface displayed by a display device and having a switchable operation mode, the display device being adapted to provide a first optical signal, and the operating apparatus comprising:
a processing module;
a light-emitting element electrically connected to the processing module;
a light sensing element electrically connected to the processing module; and
a switching module electrically connected to the processing module and adapted to switch the switchable operation mode to a first mode or a second mode, wherein when the switchable operation mode is switched to the first mode, the light sensing element receives the first optical signal, when the switchable operation mode is switched to the second mode, the light-emitting element provides a second optical signal and the switching module enables the light sensing element to receive the second optical signal.

2. The operating apparatus according to claim 1, further comprising a casing, the processing module, the light-emitting element, the light sensing element and the switching module being disposed in the casing, the casing having a first wall and a second wall interconnected with the first wall, the first wall and the second wall respectively defining a first opening and a second opening therein, the second optical signal provided by the light-emitting element entering in or leaving the casing through the second opening.

3. The operating apparatus according to claim 2, wherein the switching module comprises a rotatable element electrically connected to the processing module, the light sensing element is fixed to the rotatable element, when the switchable operation mode is switched to the first mode, the rotatable element drives the light sensing element to make a light sensing surface of the light sensing element face the first opening, when the switchable operation mode is switched to the second mode, the rotatable element drives the light sensing element to make the light sensing surface of the light sensing element face the second opening.

4. The operating apparatus according to claim 2, wherein a light sensing surface of the light sensing element faces the first opening, the switching module comprises a reflecting element disposed between the light sensing element and the first wall of the casing, and electrically connected to the processing module, when the switchable operation mode is switched to the first mode, the processing module drives the reflecting element to move away from a position between the light sensing surface and the first opening, so that the first optical signal entered into the casing from the first opening is received by the light sensing surface of the light sensing element, when the switchable operation mode is switched to the second mode, the processing module drives the reflecting element to move to the position between the light sensing surface and the first opening, so that the second optical signal entered into the casing from the second opening is reflected to the light sensing surface of the light sensing element by the reflecting element.

5. The operating apparatus according to claim 2, wherein a light sensing surface of the light sensing element faces the first opening, the switching module comprises an electronic polarization element disposed between the light sensing element and the first opening and electrically connected to the processing module, when the switchable operation mode is switched to the first mode, the processing module switches the electronic polarization element to a first state, so that the first optical signal entered into the casing from the first opening passes through the electronic polarization element and is received by the light sensing surface of the light sensing element, when the switchable operation mode is switched to the second mode, the processing module switches the electronic polarization element to a second state, so that the second optical signal entered into the casing from the second opening is reflected to the light sensing surface of the light sensing element by the electronic polarization element.

6. The operating apparatus according to claim 2, wherein a light sensing surface of the light sensing element faces the first opening, the switching module comprises a Micro Electro Mechanical System (MEMS) reflecting element disposed between the light sensing element and the first opening of the casing and electrically connected to the processing module, when the switchable operation mode is switched to the first mode, the processing module switches the MEMS reflecting element to a first state, so that the first optical signal entered into the casing from the first opening passes through the MEMS reflecting element and is received by the light sensing surface of the light sensing element, when the switchable operation mode is switched to the second mode, the processing module switches the MEMS reflecting element to a second state, so that the second optical signal entered into the casing from the second opening is reflected to the light sensing surface of the light sensing element by the MEMS reflecting element.

7. The operating apparatus according to claim 1, wherein the processing module comprises a first processing unit electrically connected to the light sensing element, when the switchable operation mode is switched to the first mode, the first processing unit calculates coordinates of at least an object in a plurality of first images sensed by the light sensing element according to the first images.

8. The operating apparatus according to claim 7, wherein the processing module further comprises a second processing unit electrically connected to the light sensing element, when the switchable operation mode is switched to the second mode, the second processing unit calculates a movement information of the operating apparatus with respect to a working surface according to a plurality of second images sensed by the light sensing element.

9. The operating apparatus according to claim 8, wherein the processing unit further comprises a transmission element electrically connected to the first processing unit and the second processing unit, the transmission element is adapted to transmit the movement information of the operating apparatus to the display device.

10. The operating apparatus according to claim 9, wherein the transmission element comprises at least one of a wire transmission element and a wireless transmission element.

11. The operating apparatus according to claim 2, wherein the switching module further comprises a switch key disposed in the casing and electrically connected to the processing module.

12. The operating apparatus according to claim 1, wherein the processing module controls the switching module to switch the switchable operation mode according to image signals received by the light sensing element.

13. An interactive image system comprising:
a display device adapted to display an operating interface and to provide a first optical signal; and
an operating apparatus adapted to manipulate the operating interface and having a switchable operation mode, the operating apparatus comprising:
a processing module;
a light-emitting element electrically connected to the processing module;
a light sensing element electrically connected to the processing module; and
a switching module electrically connected to the processing module and adapted to switch the switchable operation mode to a first mode or a second mode, wherein when the switchable operation mode is switched to the first mode, the light sensing element receives the first optical signal, when the switchable operation mode is switched to the second mode, the light-emitting element provides a second optical signal and the switching module enables the light sensing element to receive the second optical signal.

14. The interactive image system according to claim 13, wherein the operating apparatus further comprises a casing, the processing module, the light-emitting element, the light sensing element and the switching module are disposed in the casing, the casing has a first wall and a second wall interconnected with the first wall, the first wall and the second wall respectively define a first opening and a second opening therein, the second optical signal provided by the light-emitting element enters in or leaves the casing through the second wall.

15. The interactive image system according to claim 14, wherein the switching module comprises a rotatable element electrically connected to the processing module, the light sensing element is fixed to the rotatable element, when the switchable operation mode is switched to the first mode, the rotatable element drives the light sensing element to make a light sensing surface of the light sensing element face the first opening, when the switchable operation mode is switched to the second mode, the rotatable element drives the light sensing element to make the light sensing surface of the light sensing element face the second opening.

16. The interactive image system according to claim 14, wherein a light sensing surface of the light sensing element faces the first opening, the switching module comprises a reflecting element disposed between the light sensing element and the first wall of the casing and electrically connected to the processing module, when the switchable operation mode is switched to the first mode, the processing module drives the reflecting element to move away from a position between the light sensing surface and the first opening, so that the first optical signal entered into the casing from the first opening is received by the light sensing surface of the light sensing element, when the switchable operation mode is switched to the second mode, the processing module drives the reflecting element to move to the position between the light sensing surface and the first opening, so that the second optical signal entered into the casing from the second opening is reflected to the light sensing surface of the light sensing element by the reflecting element.

17. The interactive image system according to claim 14, wherein a light sensing surface of the light sensing element faces the first opening, the switching module comprises an electronic polarization element disposed between the light sensing element and the first opening and electrically connected to the processing module, when the switchable operation mode is switched to the first mode, the processing module switches the electronic polarization element to a first state, so that the first optical signal entered into the casing from the first opening passes through the electronic polarization element and is received by the light sensing surface of the light sensing element, when the switchable operation mode is switched to the second mode, the processing module switches the electronic polarization element to a second state, so that the second optical signal entered into the casing from the second opening is reflected to the light sensing surface of the light sensing element by the electronic polarization element.

18. The interactive image system according to claim 14, wherein a light sensing surface of the light sensing element faces the first opening, the switching module comprises a Micro Electro Mechanical System (MEMS) reflecting element disposed between the light sensing element and the first opening of the casing and electrically connected to the processing module, when the switchable operation mode is switched to the first mode, the processing module switches the MEMS reflecting element to a first state, so that the first optical signal entered into the casing from the first opening passes through the MEMS reflecting element and is received by the light sensing surface of the light sensing element, when the switchable operation mode is switched to the second mode, the processing module switches the MEMS reflecting element to a second state, so that the second optical signal entered into the casing from the second opening is reflected to the light sensing surface of the light sensing element by the MEMS reflecting element.

19. The interactive image system according to claim 13, wherein the processing module comprises a first processing unit electrically connected to the light sensing element, when the switchable operation mode is switched to the first mode, the first processing unit calculates coordinates of at least an object in a plurality of first images sensed by the light sensing element according to the first images.

20. The interactive image system according to claim 19, wherein the processing module further comprises a second processing unit electrically connected to the light sensing element, when the switchable operation mode is switched to the second mode, the second processing unit calculates a movement information of the operating apparatus with respect to a working surface according to a plurality of second images sensed by the light sensing element.

21. The interactive image system according to claim 20, wherein the processing unit further comprises a transmission element electrically connected to the first processing unit and the second processing unit, the transmission element is adapted to transmit the movement information of the operating apparatus to the display device.

22. The interactive image system according to claim 21, wherein the transmission element comprises at least one of a wire transmission element and a wireless transmission element.

23. The interactive image system according to claim 14, wherein the switching module further comprises a switch key disposed in the casing and electrically connected to the processing module.

24. The interactive image system according to claim 13, wherein the processing module controls the switching module to switch the switchable operation mode according to image signals received by the light sensing element.
